(19) United States
(12) Patent Application Publication
(10) Pub. No.: US 2018/0218374 A1
(43) Pub. Date: Aug. 2, 2018

(54) METHOD, SYSTEM AND COMPUTER PROGRAM PRODUCT FOR FACILITATING QUERY RESOLUTIONS AT A SERVICE DESK

(71) Applicant: MOVEWORKS, INC., Fremont, CA (US)

(72) Inventors: Bhavin Nicholas SHAH, Fremont, CA (US); Vaibhav NIVARGI, Mountain View, CA (US); Vachan WODEYAR, San Jose, CA (US); Varun SINGH, San Francisco, CA (US)

(21) Appl. No.: 15/421,339

(22) Filed: Jan. 31, 2017

(51) Int. Cl. G06Q 30/00; G06F 17/30

(52) U.S. Cl. CPC G06Q 30/016; G06F 17/30522

(57) ABSTRACT

Method, system and computer program product for facilitating query resolution at a service desk associated with an enterprise are disclosed. A user interface (UI) is provisioned to a user to enable the user to provide a query to a virtual agent. The virtual agent engages in an interaction with the user to determine whether the query is a service request or an incident. If the query is determined to be a service request, then a service request form is updated based on the interaction. The updated service request form is routed to a resolver queue identified to be relevant to the service request. If the query is determined to be an incident, then a reply to the query is identified from a knowledge base and the reply is provisioned to the user using the UI.

### TECHNICAL FIELD

The present technology generally relates to resolving queries of enterprise users and, more particularly, to a method and system for facilitating query resolutions at service desks associated with the enterprises.

### BACKGROUND

Typically, incidents or service requests raised by employees of an enterprise go through multiple stages before resolution. While an incident may relate to an interruption in service, deterioration in service quality or a bottleneck in operations as experienced by an employee of the enterprise, a service request usually relates to a formal request submitted by an employee requesting for some type of service, software, or hardware. When an employee is faced with an issue or has a query to resolve, the employee may try searching for an answer in a proprietary knowledge database of the enterprise. In some cases, due to fragmented and outdated knowledge maintained in the proprietary knowledge database, the employee may fail to obtain a suitable answer. The search interfaces provided to the employees may also be ill-equipped to handle the queries, as the problems experienced by employees are usually expressed in a high level language, which may be not be mapped to the system level keywords of the search interface. This may lead to a poor experience in self-resolution of queries for the employees and result in a loss of employee productivity.

Further, incase the employee is unable to find a suitable answer, the employee may need to fill up and submit a service request form if the query relates to a service request or raise a ticket if the query relates to an incident. Often the employee is unable to determine if the issue or the query relates to a service request or an incident. As a result, the employee may report the service request as the incident or the incident as the service request. Further, in many scenarios, the employee may be unable to locate the correct service request form to fill and may fill up an incorrect form, or may raise an incorrect ticket. Further, it is common for employees to submit forms or raise tickets with incomplete information, thereby resulting in an inaccurate description of the incidents or the service requests.

When such an incomplete or inaccurately filled ticket or a service request form is routed to a triaging agent of the service desk, the triaging agent often needs to rectify the incorrect information and fill out the missing information by guessing the issue or by contacting the employee. Such manual process may result in loss of time and inconsistency in collecting information. As a result, precious time and resources of the enterprise are expended in retrieving correct and complete information required for creation of a complete ticket or a service request form.

Furthermore, the triaging agent may be responsible for determining and routing the ticket or the service request form to a queue handled by a designated human agent specialized in resolving and diagnosing a particular type of issues. Even though the triaging agent may assign the ticket or the service request form to the relevant queue based on manual judgment, it is commonly observed that the ticket or the service request form bounces between multiple queues before reaching a correct queue. As the manual judgment of the triaging agent may lead to poor assignment of the ticket or the service request form, bouncing of the ticket/service request form across irrelevant queues may reduce an overall efficiency of the service desk.

In view of the above, there is a need to overcome the drawbacks of conventional query resolution mechanisms at service desks of the enterprises and facilitate resolution of queries of enterprise users in an efficient manner.

### SUMMARY

Various embodiments of the present disclosure provide a method, system and a computer program product for facilitating query resolutions at a service desk associated with an enterprise.

In an embodiment, a system for facilitating query resolution at a service desk associated with an enterprise is disclosed. The system includes at least one processor and a memory having stored therein machine executable instructions, that when executed by the at least one processor, causes the system to provision a user interface (UI) to a user to enable the user to provide a query to a virtual agent. The system causes the virtual agent to engage in an interaction with the user. The interaction is configured to facilitate determination of whether the query is a service request or an incident. The interaction between the virtual agent and the user is facilitated using the UI. Subsequent to determining the query to be the service request, the system is further caused to update a service request form, where the service request form is identified from among a plurality of service request forms based on the interaction. A resolver queue relevant to the service request is identified from among a plurality of resolver queues associated with the service desk, and the updated service request form is routed to the resolver queue identified to be relevant to the service request. Subsequent to determining the query to be the incident, the system is caused to identify a reply to the query from a knowledge base, and provision the reply to the user using the UI.

In an embodiment, a computer-implemented method for facilitating query resolution at a service desk associated with an enterprise is disclosed. The method provisions a user interface (UI) to a user, by a processor, to enable the user to provide a query to a virtual agent. The method causes the virtual agent to engage in an interaction with the user by the processor. The interaction is configured to facilitate determination of whether the query is a service request or an incident. The interaction between the virtual agent and the user is facilitated using the UI. The method performs, by the processor, subsequent to determining the query to be the service request, updating a service request form. The service request form is identified from among a plurality of service request forms based on the interaction. A resolver queue relevant to the service request is identified from among a plurality of resolver queues associated with the service desk, and the updated service request form is routed to the resolver queue identified to be relevant to the service request. The method performs, by the processor, subsequent to determining the query to be the incident, identifying a reply to the query from a knowledge base, and provisioning the reply to the user using the UI.

In an embodiment, a computer program product for facilitating query resolution at a service desk associated with an enterprise includes at least one computer-readable storage medium. The computer-readable storage medium includes a set of instructions, which, when executed by one or more processors, cause an electronic device to provision a user interface (UI) to a user to enable the user to provide a query to a virtual agent. The electronic device causes the virtual agent to engage in an interaction with the user. The interaction is configured to facilitate determination of whether the query is a service request or an incident. The interaction between the virtual agent and the user is facilitated using the UI. Subsequent to determining the query to be the service request, the electronic device is further caused to update a service request form, where the service request form is identified from among a plurality of service request forms based on the interaction. A resolver queue relevant to the service request is identified from among a plurality of resolver queues associated with the service desk, and the updated service request form is routed to the resolver queue identified to be relevant to the service request. Subsequent to determining the query to be the incident, the electronic device is caused to identify a reply to the query from a knowledge base, and provision the reply to the user using the UI.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 shows a representation of a process flow associated with resolution of queries of users of an enterprise, in accordance with an example scenario;

FIG. 2 is a block diagram of the system configured to facilitate query resolution at a service desk associated with an enterprise, in accordance with an example embodiment;

FIG. 3 shows a user interface (UI) displaying an example interaction between a user and a virtual agent, in accordance with an example embodiment;

FIG. 4 shows a UI displaying an example interaction between a user and a virtual agent, in accordance with another example embodiment;

FIGS. 5A and 5B show a UI displaying another example interaction between a user and a virtual agent, in accordance with an example embodiment;

FIG. 6 shows a UI displaying a natural language interaction between a user and a virtual agent, in accordance with an example embodiment;

FIG. 7 shows a UI displaying a natural language interaction between a user and a virtual agent, in accordance with another example embodiment;

FIG. 8 shows an example representation of a process flow for facilitating resolution of user queries, in accordance with an example embodiment;

FIG. 9 is a flow diagram of an example method for facilitating query resolution at a service desk associated with an enterprise, in accordance with an example embodiment; and

FIG. 10 is a flow diagram of an example method for facilitating query resolution at a service desk associated with an enterprise, in accordance with another example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

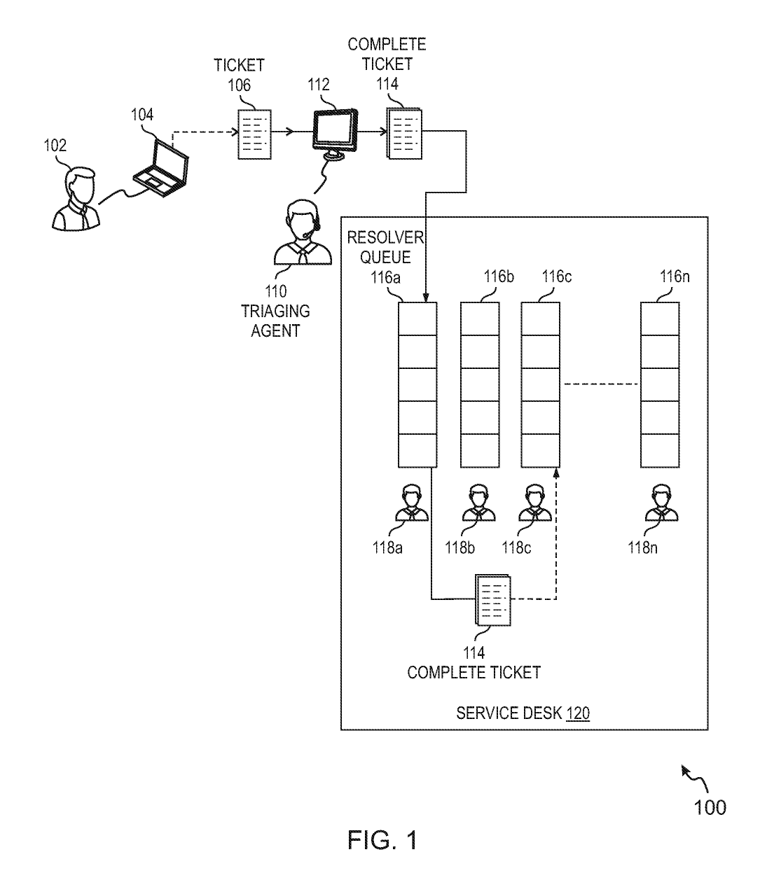

FIG. 1 shows a representation of a process flow 100 associated with resolution of queries of users of an enterprise, in accordance with an example scenario. The process flow 100 depicts a user 102 engaged in resolving an issue with support from a service desk 120 associated with an enterprise. The term ‘user’ as used herein refers to an employee, a contractor, or a customer associated with the enterprise. Moreover, the term ‘service desk’ may refer to an Information Technology (IT) service desk of the enterprise. The user 102 may use a device 104 (exemplarily depicted to be a laptop computer) to connect to the service desk 120 (for example, by using local enterprise intranet or any such network communication means) and provide the query. It is noted that the device 104 is depicted to be a laptop computer for illustration purposes and that the user may provide a query using other electronic devices, such as a desktop computer, a workstation terminal, a mobile phone, a Smartphone, a wearable device, a tablet computer, a personal digital assistant, and the like.

In an example scenario, the user 102 may initially try to search for answers to the query from available data sources such as the Internet, Frequently Asked Questions (FAQ) listed on the enterprise Website, help sections of proprietary databases of the enterprise, and the like. As such data sources are usually unstructured, the user 102 may fail to obtain a satisfactory answer to the query, and may proceed to raise a ticket 106.

The ticket 106 may include a description of the query as provided by the user 102. The ticket may be forwarded to a client device 112 associated with a triaging agent 110. As the user 102 is usually inexperienced in filling out the ticket 106, the triaging agent 110 may often need to rectify incorrect information, guess missing information in the ticket 106 and communicate with the user 102 to receive accurate information as necessary for generating a complete ticket 114. Such a manual process of generating the complete ticket 114 is usually tedious and error prone, as the triaging agent 110 may fail in some cases to capture the query correctly due to lack of proper communication and understanding. Further, the complete ticket 114 may be routed by the triaging agent 110 to a resolver queue 116a from among a plurality of resolver queues 116a-n associated with the service desk 120. As can be seen, each resolver queue of the service desk 120 is associated with a human agent (referred to herein as a ‘resolver’) specialized to handle incidents and/or service requests of a particular query domain. For example, a resolver 118a is designated to the resolver queue 116a, a resolver 118b is designated to the resolver queue 116b, a resolver 118c is designated to the resolver queue 116c and a resolver 118n is designated to the resolver queue 116n. However, incase the triaging agent 110 fails to determine an appropriate domain of the complete ticket 114, the resolver queue 116a may be inappropriate for effecting resolution of the complete ticket 114. Hence, the resolver 118a of the resolver queue 116a may further route the complete ticket 114 to a second resolver queue such as the resolver queue 116c, if the resolver 118a opines that the resolver queue 116c is an appropriate resolver queue for effecting resolution of the complete ticket 114. Such a routing process of the complete ticket 114 may continue between one or more resolver queues 116a-n, until the complete ticket 114 reaches a relevant resolver queue. As a result an overall efficiency of the service desk 120 in resolution of the ticket 106 is decreased due to inaccurate information provided within the ticket 106 and incorrect routing of the complete ticket 114.

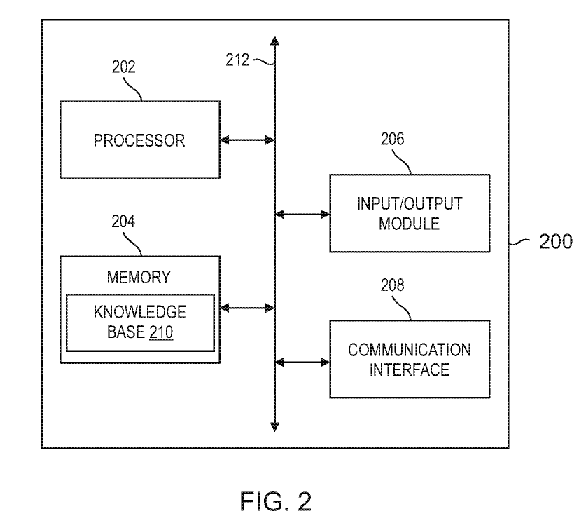

Various embodiments of the present technology provide a method, a system and a computer program product that are capable of overcoming these and other obstacles and providing additional benefits. More specifically, various embodiments of the present technology disclose an operator less service desk that uses virtual agents to determine whether a user query is a service request or an incident. If the query is a service request, an appropriate service request form is identified based on the interaction between the user and the virtual agent, and routed to a relevant resolver queue. If the query is an incident, then a response to the query is identified from the knowledge base and provided to the user. If the user is not satisfied by the response, then a complete and accurately filled ticket is generated based on the interaction and routed to an appropriate resolver queue of the service desk for resolution. A system configured to facilitate query resolution at a service desk associated with an enterprise is explained with reference to FIG. 2.

FIG. 2 is a block diagram of the system 200 configured to facilitate query resolution at a service desk associated with an enterprise, in accordance with an example embodiment. The system 200 includes at least one processor such as a processor 202, at least one memory such as a memory 204, an input/output (I/O) module 206 and a communication interface 208. Although the system 202 is depicted to include only one processor 202, the system 200 may include more number of processors therein. In an embodiment, memory 204 is capable of storing platform instructions. Further, the processor 202 is capable of executing the stored platform instructions. In at least one example embodiment, the stored platform instructions include machine learning and artificial intelligence (AI) routines that may facilitate machine based interaction, for example a speech-based interaction or a chat-based interaction, with a human. More specifically, the memory 204 includes computer programs with corresponding executable instructions that, in essence, configure a virtual agent, which is capable of interacting with a human, such as for example an employee of an enterprise.

In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, and the like. In an embodiment, the processor 202 may be configured to execute hard-coded functionality. In an embodiment, the processor 202 may be embodied as an executor of software instructions, wherein the software instructions may specifically configure the processor 202 to perform algorithms and/or operations described herein when the software instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.).

The memory 204 includes a knowledge base, such as the knowledge base 210. The knowledge base 210 serves as a store of user queries that are anticipated at the service desk of the enterprise. The user queries stored in the knowledge base 210 are referred to herein as ‘system queries’. The system queries are stored along with corresponding answers in the knowledge base 210. Upon receiving a query from a user that matches a system query stored in the knowledge base 210, an answer corresponding to that system query may be provided as a reply to the user. In some embodiments, the system queries are stored along with corresponding answers using a hierarchical storage model to facilitate ease of matching a user query to a system query. In such a scenario, the information stored in the knowledge base 210 configures a knowledge graph including a network of interconnected nodes and branches. The knowledge graph may be systematically pruned to match a user query to a system query as will be explained in detail later. Further, in at least one example embodiment, the system queries are tagged with keywords and other such metadata to facilitate ease of retrieval from the knowledge base 210. The system queries and the corresponding answers and keywords together configure the information stored in the knowledge base 210, and this information is constantly updated/fine-tuned based on observed real-time usage behavior of users of the enterprise. In at least one example embodiment, the processor 202 may be configured to communicate, using the communication interface 208, with public data sources (for example, sources like Wikipedia™, technical community forums, etc.) and private data sources (for example, online technical libraries) to augment information stored in the knowledge base 210. Accordingly, multiple forms of asking a system query are stored for each type of user concern, in the knowledge base 210.

The I/O module 206 is configured to facilitate provisioning of an output to a user of the system 200 and/or for receiving an input from the user of the system 200. The I/O module 206 is configured to be in communication with processor 202 and memory 204. Examples of the I/O module 206 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a vibrator, a light emitting diode display, a thin-film transistor (TFT) display, a liquid crystal display, an active-matrix organic light-emitting diode (AMOLED) display, and the like. In an example embodiment, the processor 202 may include I/O circuitry configured to control at least some functions of one or more elements of I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication interface 208 enables the system 200 to communicate with other entities over various types of wired, wireless or combinations of wired and wireless networks, such as for example, the Internet. In at least one example embodiment, the communication interface 208 includes a transceiver circuitry configured to enable transmission and reception of data signals over the various types of communication networks. In some embodiments, the communication interface 208 may include appropriate data compression and encoding mechanisms for securely transmitting and receiving data over the communication networks. The communication interface 208 facilitates communication between the system 200 and servers hosting the operator-less service desk, servers hosting the enterprise website, public data sources, private data sources, electronic devices associated with the users, electronic devices associated with the human agents, and the like. In an example embodiment, the communication interface 208 is capable of facilitating communication between the system 200 and various resolver queues associated with the service desk of the enterprise, such as the resolver queues 116a-n explained with reference to FIG. 1.

Further, the communication interface 208 may be configured to effect a display of a user interface (UI), such as for example a chat application UI or a voice-application UI, on a device associated with a user of the enterprise. The communication interface 208 may also serve to receive inputs provided to the UI by the user and relay responses from the virtual agent to the user using the UI. To that effect, the communication interface 208 may include relevant Application Programming Interfaces (APIs) to facilitate a UI-based interaction between the user and the virtual agent.

In an embodiment, various components of the system 200, such as the processor 202, the memory 204, the I/O module 206 and the communication interface 208 may be configured to communicate with each other via or through a centralized circuit system 212. The centralized circuit system 212 may be various devices configured to, among other things, provide or enable communication between the components (202 -208) of the system 200. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

The system 200 as illustrated and hereinafter described is merely illustrative of a system that could benefit from embodiments of the invention and, therefore, should not be taken to limit the scope of the invention. In at least one example embodiment, the system 200 may be deployed in an enterprise server associated with a service desk of the enterprise. The service desk, as described herein, is implemented as an operator-less system capable of assisting enterprise users with their respective queries. It is noted that the service desk is capable of performing several other functions in addition to assisting users with query resolutions. For example, the service desk may assign human agents to physical tasks like hardware deployment, software installation, network maintenance, and the like. The system 200 may be configured to be in operative communication with such a service desk to facilitate resolution of queries from the enterprise users. It is noted that the system 200 may include fewer or more components than those depicted in FIG. 2. As explained above, the system 200 may be included within or embody an electronic device. Moreover, the system 200 may be implemented as a centralized system, or, alternatively, the various components of system 200 may be deployed in a distributed manner while being operatively coupled to each other.

The resolution of a query by the system 200 is explained hereinafter with reference to a single query from an enterprise user. It is noted that the system 200 may be configured to facilitate resolution of several types of queries from a plurality of enterprise users.

In at least one example embodiment, the processor 202 is configured to, with the content of the memory 204, cause the system 200 to provision a user interface (UI) to a user to enable the user to provide a query to a virtual agent. In many example scenarios, the user may need assistance with a query and may attempt to connect with a service desk associated with the enterprise. As explained above, the term ‘service desk’ refers to a single point of contact between users and Information Technology Service Management (ITSM) of the enterprise. In an example embodiment, the service desk may include a call center or an IT help desk supported by human agents. As explained above, the term ‘user’ may refer to an employee, a contractor, a customer or any such individual, who may approach the service desk for resolution of queries. The term ‘query’ as used herein refers either to a service request or an incident. A service request usually relates to a formal request made by a user of the enterprise for certain services, software or hardware that the user may need. An example of a service request may include request for login access to a local printer installed within the enterprise. The incident usually relates to an interruption in service, deterioration in service quality, a bottleneck in operation as experienced by the user of the enterprise. An example of an incident may include loss of network connectivity experienced by the user due to disruption of communication lines. Based on a type of the query (i.e. a service request or an incident), the query may be routed to the service desk for resolution. The term ‘resolution of queries’ as used herein refers to providing a satisfactory solution to the incidents or the service requests as applicable.

In an illustrative example, a user may need access to a database to complete a task. Upon trying to login, the user may get an ‘Access Denied’ message. In such a scenario, the user may wish to connect with the service desk to resolve the issue and obtain access to the database. Accordingly, the user may click on the Help section displayed on the intranet portal or may provide a click or a touch input on a hyperlink or a widget displayed on the enterprise website, to seek assistance from the service desk. Such an input may be captured, for example through Hypertext Markup Language (HTML) tags or JavaScript tags embedded on the intranet portal or the enterprise Website. The recorded input may be received by the communication interface 208 from the server hosting the operator-less service desk (or from the server hosting the intranet portal or the enterprise website). The communication interface 208 may provision the input to the processor 202, which may be configured to provision a UI capable of facilitating an interaction between the user seeking assistance and a virtual agent. In an example embodiment, the UI may be configured to facilitate a chat interaction. Accordingly, in such a scenario, the UI may correspond to an instant messaging application UI. In another example embodiment, the UI may correspond to facilitate a voice interaction (such as for example, voice-over-IP (VOIP) call) and accordingly, the UI may correspond to VOIP application UI. In another example embodiment, the UI may correspond to a display-based interactive voice response (IVR) UI. As explained above, the user may provide one or more queries using the UI.

In at least one example embodiment, the processor 202 is configured to, with the content of the memory 204, cause the system 200 to cause the virtual agent to engage in an interaction with the user. As explained above, the memory 204 stores machine learning & AI routines, which in effect, configure a virtual agent (i.e. a virtual assistant) capable of conducting a machine-based interaction with a human. The virtual agent may be invoked upon provisioning of the UI to the user. The virtual agent may be configured to engage in an interaction with agent to learn more about the query. More specifically, the virtual agent may engage in an interaction with the user to determine whether the query is a service request or an incident.

In at least one example embodiment, the interaction between the virtual agent and the user involves displaying one or more system queries stored in the knowledge base 210 to the user on the UI. As explained above, the memory 204 includes the knowledge base 210, which serves as a store of several system queries with corresponding answers. In at least one example embodiment, the term ‘causing the virtual agent to engage in an interaction with the user’ implies providing the virtual agent with one or more system queries that are likely to match with the user query from the knowledge base 210. The virtual agent may request the user to confirm if a system query from among the one or more system queries substantially matches the user requirements. The term ‘substantially matches’ as used herein implies a system query matches at least the content (for example, a sequence of words) or implied intention from the user. If the user identifies one system query from among the displayed system queries to match the user's query, the processor 102 may be able to interpret the user's query (for example, may relate the user's query to stored interpretation of the matching system query) and accordingly determine the system query to be a service request or an incident.

However, in some embodiments, no system query from among the one or more displayed system queries may match the query from the user. In such a scenario, the system 200 may be caused to repeat display of another set of system queries and request the user to confirm if the user's query matches any of the displayed system queries. More specifically, if the user's response to the displayed system queries indicates no match with the system query, then the processor 102 may be configured to prune the knowledge graph (i.e. remove parts of the knowledge graph associated with the previous set of system queries from a current search domain) to identify a different set of system queries that are more likely to match the user query.

In at least one example embodiment, the system 200 may be caused to repeat the steps of displaying system queries and causing identification of a matching system query, a predefined number of times, if an user input in response to the displaying the system queries is indicative of no match between the system queries and the query provided by the user. In an illustrative example, the system 200 may be caused to repeat the steps of displaying different set of system queries and requesting confirmation, three times. It is noted that three times repetition of steps is mentioned herein for illustration purpose. It is noted the repetition of steps may be performed fewer or more times to facilitate determination of whether the query is a service request or a query. It is also noted that the displaying of system queries and requesting subsequent confirmation by the virtual agent, in effect, configures the interaction between the user and the virtual agent.

In an embodiment, the user query may be determined to an incident based on the interaction between the user and the virtual agent. Subsequent to determining the query to be an incident, in at least one example embodiment, the processor 202 is configured to, with the content of the memory 204, cause the system 200 to identify a reply to the query from the knowledge base 210, and provision the reply to the user using the UI. As explained with reference to FIG. 2, the knowledge base 210 stored in the memory 204 is configured to store system queries along with corresponding answers. If a user query is determined to an incident, then an answer of a matching system query (i.e. a system query matching the user query) may be provided as a reply to the user. In some embodiments, the reply provided to the user may serve the user's purpose. In such a scenario, the resolution of query may be achieved without requiring any assistance from a human agent. However, in some embodiments, the reply provided to the user may be deemed to be unsatisfactory by the user. In at least one example embodiment, the processor 202 is configured to, with the content of the memory 204, cause the system 200 to generate a ticket corresponding to the query if the reply provided to the user is deemed to be unsatisfactory by the user. The ticket is generated based on the query and the interaction between the user and the virtual agent. More specifically, processor 102, using machine learning and AI routines may be configured to interpret the interaction and summarize the query and the interaction to generate an accurate and complete ticket. It is noted that in absence of the interaction with the virtual agent, the ticket may have been generated based on the query itself. A triaging agent, such as the triaging agent 110 explained with reference to FIG. 1, may have to interpret the query and contact the user to fill up the missing information or correct the interpretation of the query, thereby delaying the query resolution process.

In at least one example embodiment, the system 200 is further caused to route the ticket to a resolver queue from among the plurality of resolver queues determined to be relevant to the ticket. The determination of the appropriate resolver queue may be performed based on the complete and accurate ticket generated corresponding to the query. As explained with reference to FIG. 1, each resolver queue is associated with at least one human agent, who is specialized in handling queries related to a query domain assigned to the resolver queue. For example, a query domain related to a resolver queue may be ‘network access’. Accordingly, the human agent (also interchangeably referred to herein as the ‘resolver’) associated with a resolver queue may be an expert in resolving network-related issues and concerns of the users of the enterprise. Upon receiving the ticket, the human agent may engage with the user to assist the user. In at least one example embodiment, the system 200 may be caused to facilitate the query resolution process by the human agent by providing the human agent with information, such as for example, a context of the query, data related to how a similar query was solved in the past etc. It is noted that the identification of the appropriate resolver queue based on the complete and accurate ticket precludes the redirection of ticket multiple times among resolver queues to identify the correct resolver queue, as observed in conventional query resolution mechanisms.

In at least one example embodiment, the processor 202 is configured to, with the content of the memory 204, cause the system 200 to identify an information gap in the knowledge base 210 subsequent to the provisioned reply being deemed unsatisfactory by the user. The system 200 may further be caused to update the knowledge base with the resolution to the query provided by the human agent in response to the identification of the knowledge gap. The updating of the knowledge base may address the identified information gap in the knowledge base 210.

In some embodiments, based on the interaction between the user and the virtual agent, the query may be determined to be a service request. Subsequent to determining the query to be the service request, in at least one example embodiment, the processor 202 is configured to, with the content of the memory 204, cause the system 200 to update a service request form. The service request form may be identified from among a plurality of service request forms based on the information obtained from the interaction between the user and the virtual agent.

The system 200 may further be caused to identify a resolver queue relevant to the service request from among a plurality of resolver queues associated with the service desk. The appropriate resolver queue may be identified based on the updated service request form. The system 200 may then be configured to route the updated service request form to the resolver queue identified to be relevant to the service request. The resolver or the human agent may then resolve the query of the user.

In at least one example embodiment, the processor 202 is configured to, with the content of the memory 204, cause the system 200 to provide notifications to one or more other users anticipated to have queries similar to the query provided by the user. The system 200 may further be caused to facilitate resolution to the similar queries based on the interaction between the virtual agent and the user.

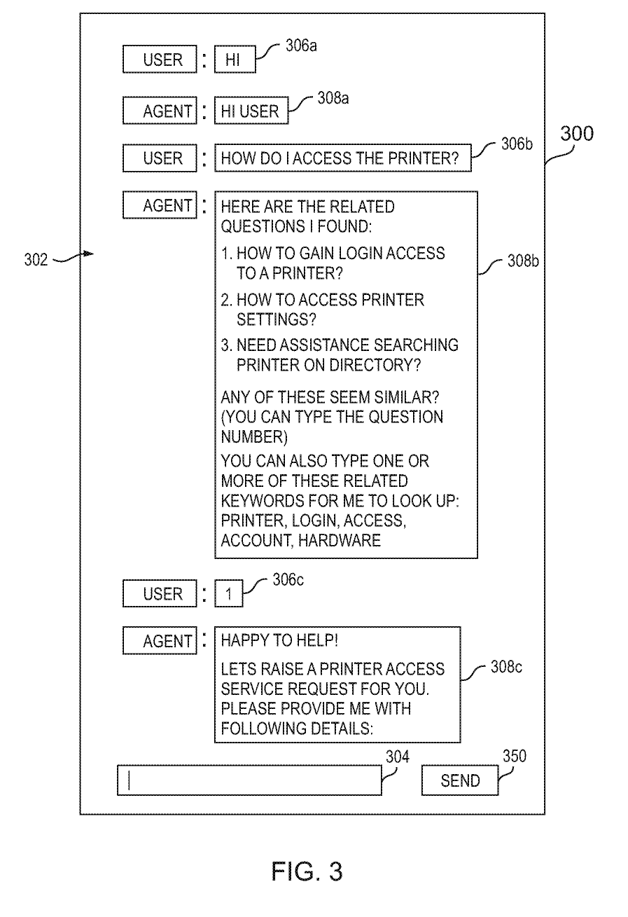

The determination of whether the query is a service request or an incident and the subsequent resolution of the query based on the said determination, is further explained with reference to illustrative examples in FIGS. 3, 4, 5A-5B and 6.

Referring now to FIG. 3, a user interface (UI) 300 displaying an example interaction 302 between a user and a virtual agent is shown, in accordance with an example embodiment. The UI 300 may be displayed on a display screen of an electronic device associated with the user. Some non-limiting examples of such an electronic device include a workstation terminal, a desktop computer, a laptop, a smartphone, a tablet computer, a wearable device, and the like. As explained with reference to FIG. 2, the system 200 may provision a UI to a user seeking assistance from a service desk associated with an enterprise. The UI 300 is depicted to chat application UI for illustration purposes. It is noted that in some embodiments, the UI 300 may be embodied as a VOIP application UI configured to facilitate voice/video based interaction with a virtual agent. In some embodiments, the UI may also correspond to a Short Messaging Service (SMS) or an Email based UI.

The UI 300 is depicted to facilitate the interaction 302 (hereinafter referred to as chat interaction 302) between the user and the virtual agent. In the chat interaction 302, the interaction entries provided by the user are exemplarily tagged with label ‘USER’, whereas the interaction entries provided by the virtual agent are exemplarily tagged with label ‘AGENT’. It is noted that such tags are mentioned herein for illustration purpose. Indeed, the interaction lines in the chat interaction 302 may be tagged with respective names, employee IDs, usernames of the user and the virtual agent, respectively.

The UI 300 further depicts a dialog box 304 to facilitate provisioning of a text input by the user, such as an input message 306a, a query 306b or a response 306c during the interaction. The user may provide the input using a physical keyboard, a virtual keyboard, speech-recognition aid, and the like. The dialog box 304 further includes a send button 350, which may be configured to initiate transmission of a completed input to the chat recipient. The virtual agent may respond to the user inputs by displaying a corresponding output message below the associated user input within the UI 300. For example, when the user provides the input message 306a, for example “Hi”, the virtual agent may respond with a corresponding output message 308a, exemplarily depicted as “Hi USER” for instance. Similarly, when the user inputs the query 306b, i.e. “How do I access the printer?”, the virtual agent may respond with a corresponding output message 308b, which includes system queries related to the query 306b. The system queries may be retrieved from the knowledge base 210. In an embodiment, the system 200 may be caused to parse the query 306b to generate n-grams and match the n-grams with the tagged keywords corresponding to the system queries stored in the knowledge base 210 of the system 200 to retrieve the system queries related to the query 306b. The output message 308b requests the user to identify a system query matching the query provided by the user, i.e. query 306b.

In response, the user may provision the response 306c to identify the first system query to be matching the query 306b. Such a response may assist the system 200 in identifying the query 306b as a service request. For example, the first system query “How to get a login access to a printer” may be classified in the knowledge base 210 as a service request. Hence, the query 306b may be determined to be a service request. The virtual agent may provision a response 308c for thanking the user for identifying the matching system query and for outlining the next course of action (i.e. completing a service request form). As explained with reference to FIG. 2, the system 200, subsequent to identifying the query as a service request, may be caused to identify an appropriate service request form based on the chat interaction 302. For example, for the service request relating to “How to get a login access to a printer”, a service request form pertaining to printer login access may be selected as the relevant service request form. The system 200 may be caused to update the service request form. For example, the system 200 may be caused to populate text entry fields like user name, printer ID, etc. in the service request form and route the updated service request form to a resolver queue identified to be relevant to the service request, thereby facilitating resolution of the query 306b of the user. In an example scenario, a human agent associated with the resolver queue to which the service request form may be routed, may resolve the query by rendering appropriate service as requested in the service request form viz. providing the necessary login access to the user for accessing the local printer. On rendering the appropriate service, the service request form may be marked as closed thereby indicating resolution of the query.

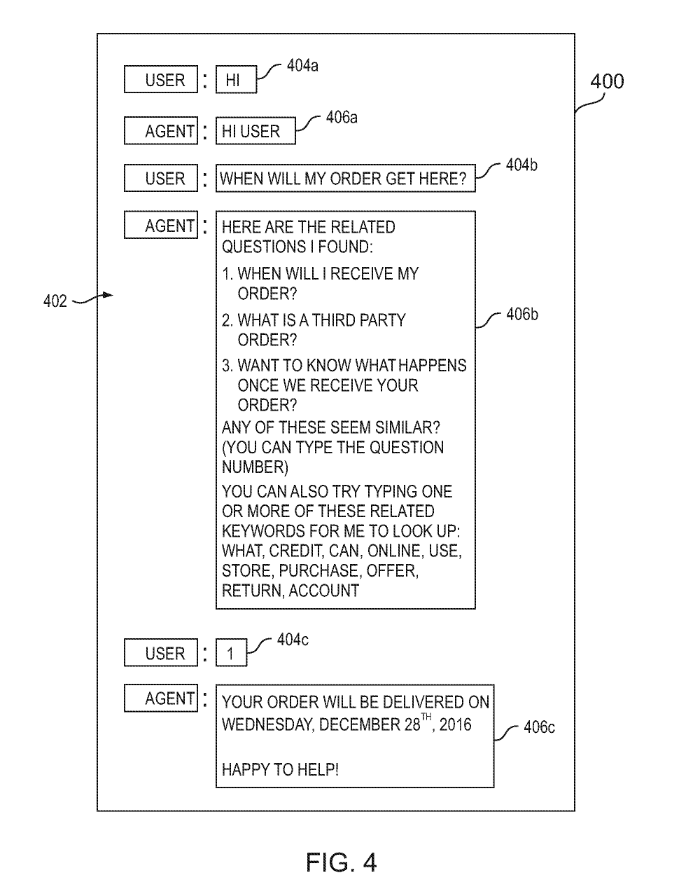

Referring now to FIG. 4, a UI 400 displaying an example interaction 402 between a user and a virtual agent is shown, in accordance with another example embodiment. The UI 400 is similar to the UI 300 and is not explained again herein. Moreover, the interaction entries in the interaction 402 (hereinafter referred to chat interaction 402) provided by the user are exemplarily tagged with label ‘USER’, whereas the interaction entries provided by the virtual agent are exemplarily tagged with label ‘AGENT’.

The user is depicted to have provided an input message 404a “Hi”, which may invoke a response 406a “Hi USER” from the virtual agent. The user may ask a query 404b “When will my order get here?”, to which the virtual agent may display a corresponding output message 406b including system queries related to the query 404b and may request the user to select a system query that is similar to the query 404b. The system queries likely to match the query 404b may be identified from the knowledge base 210 of the memory 204 as explained with reference to FIGS. 2 and 3 and is not explained again herein. In an example scenario, the user may find a first system query, i.e. “When will I receive my order?”, as similar to the query 404b from among the displayed system queries. Accordingly, the user may reply with an appropriate selection at 404c as “1”, which may identify the first system query retrieved from the knowledge base 210 to be matching the query 404b. In an example scenario, the first system query may be classified as an incident in the knowledge base 210. Accordingly, the response 404c provided by the user may facilitate determination of the query as the incident.

As explained with reference to FIG. 2, the system 200, subsequent to determining the query to be an incident, may identify a reply to be provided to the user from the knowledge base 210 and provision the reply to the user. In at least one example embodiment, the system 200 may be caused to retrieve the answer stored corresponding to the first system query and in conjunction with retrieved information corresponding to the user's order may provision the answer to the user as the reply to the query 404b. The provisioned reply is depicted as response 406c, i.e. “Your order will be delivered on Wednesday, Dec. 28, 2016. Happy to Help!”. Such a response may resolve the query of the user to user's satisfaction, and as such precludes the cumbersome task of involving a triaging agent to manually determine the nature of the query, route the query to a resolver and resolve the query.

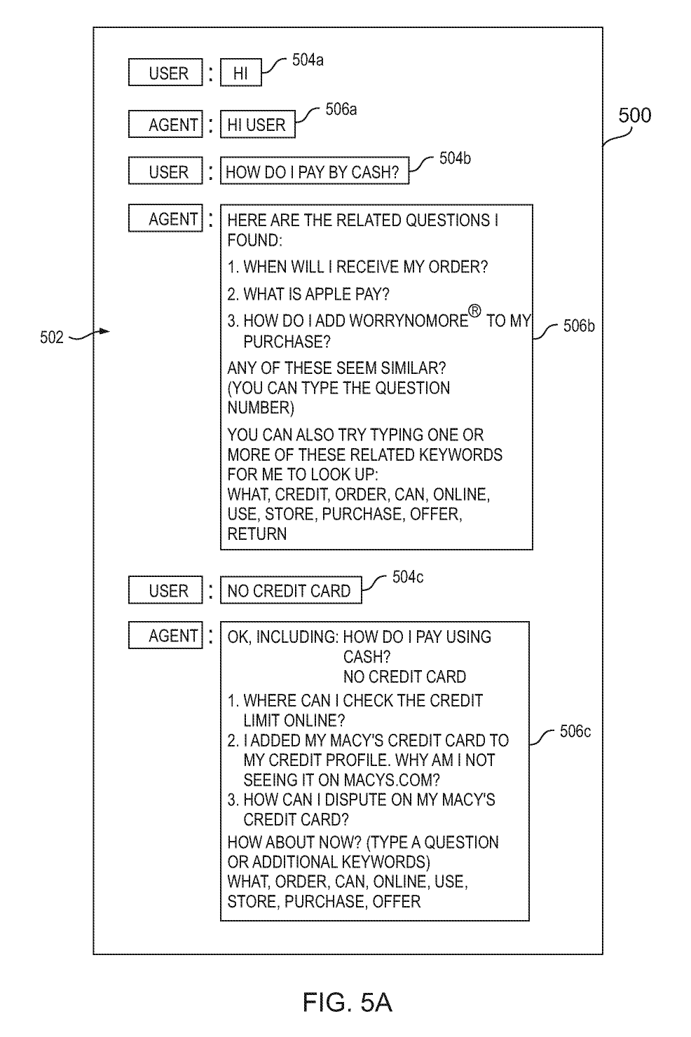

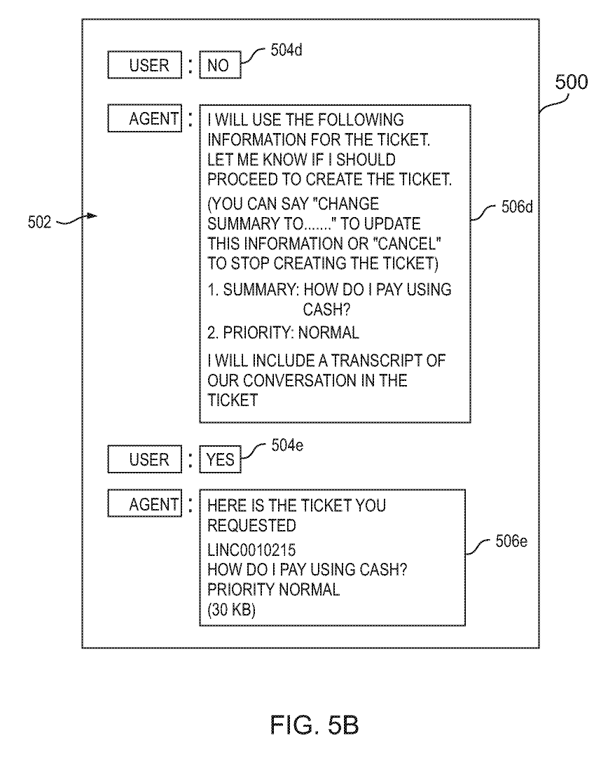

However, it is noted that, in some example scenarios, the reply provided to the user may be deemed to be unsatisfactory by the user. The resolution of query in such a scenario is explained with reference to FIGS. 5A-5B.

Referring now to FIGS. 5A and 5B, a UI 500 displaying another example interaction 502 between a user and a virtual agent is shown, in accordance with an example embodiment. The UI 500 is similar to the UI 300 and is not explained again herein. Moreover, the interaction entries in the interaction 502 (hereinafter referred to chat interaction 502) provided by the user are exemplarily tagged with label ‘USER’, whereas the interaction entries provided by the virtual agent are exemplarily tagged with label ‘AGENT’.

The user is depicted to have provided an input message 504a “Hi”, which may invoke a response 506a “Hi User” from the virtual agent. The user may ask a query 504b, such as for example “How do I pay by cash?”, to which the virtual agent may display a corresponding output message 506b including system queries related to the query 504b and may request the user to select a system query that is similar to the query 504b. The system queries likely to match the query 504b may be identified from the knowledge base 210 of the memory 204 as explained with reference to FIGS. 2 and 3 and is not explained again herein. In an example scenario, the user may find none of the system queries to be matching to the query 504b. The user may respond with a keyword response 504c “No credit card”, to further elaborate the query 504b.

As explained with reference to FIG. 2, the system 200 may be caused to repeat displaying of system queries, as part of the interaction between the virtual agent and the user, to facilitate determination of whether the query is a service request or an incident. Accordingly, the virtual agent is caused to display another set of system queries in form of the response 506c. In an example scenario, the user may respond with a response 504d, “No”, indicating that the user is not satisfied with the response 506c. In such a scenario, the system 200 may be caused to determine the query to be an incident (or more specifically, not a service request), and that the reply provided to the user is deemed to be unsatisfactory by the user. As explained with reference to FIG. 2, the system 200 may be caused to generate a ticket in response to such a query. Accordingly, the virtual agent is caused to offer generation of ticket as depicted in response 506d. The response 506d is depicted to offer generation of a ticket along with a summary of the ticket to be raised. It is noted that the ticket summary is configured to include the details of the chat interaction 502 conducted so far. More specifically, the ticket may include interaction lines 504b, 506b, 504c, 506c and 504d. The user is also offered options to change a summary of the ticket, to ratify the generation of the ticket, and the like.

When the user provides consent for the generation of the ticket, for example by providing the response 504e ‘Yes’, the system 200 may generate the ticket and the virtual agent may be caused to display the generated ticket as depicted in the response 506e. The system 200 may further be caused to route the generated ticket to a resolver queue determined to be relevant to the ticket. As explained above, a human agent associated with the resolver queue may assist the user, for example by providing options to the user to pay by cash, to facilitate resolution of the query 504b.

Further, as explained above, the system 200 may identify an information gap in the knowledge base 210 subsequent to the provisioned solution being deemed unsatisfactory by the user. Furthermore, the system 200 may update the knowledge base 210 with the resolution to the query provided by the human agent in response to the identification of the knowledge gap. In aforesaid example, the resolution to the query 504b as provided by the human agent associated with the resolver, may be updated into the knowledge base 210 to address the information gap.

In some example embodiments, the system 200 may anticipate queries that may be raised by one or more other users in the enterprise, where the queries may be similar to the query raised by a user, for example user A, whose query has recently been resolved by the system 200. For example, events such as Information Technology (IT) rollout plans, preplanned system outages, new batch of trainees joining, and the like, usually affect multiple users and may be root cause for generation of similar type of queries. The system 200 may be caused to identify queries that may be raised by other users in real-time and accelerate a time to resolution of such queries by performing one or more tasks as may be required, such as for example, providing notifications to one or more users and effecting resolutions similar to the resolution provided to the user A. Further, the system 200 may be caused to anticipate such similar queries from current and past interactions between the virtual agent and the user A.

Though the interaction between the user and the agent has been explained so far with reference to displaying a set of system queries matching the user query, in some embodiments, the system 200 may be configured to cause the virtual agent to engage in a natural language based interaction with the user to facilitate determination of whether the query is a service request or an incident. In at least some example embodiments, the user may prefer natural language form of communication to a form of communication involving selection of system queries matching the user query from among the sets of displayed system queries.

In at least one example embodiment, the memory 204 of the system 200 (shown in FIG. 2) may include machine learning algorithms and artificial intelligence (AI) routines capable of facilitating learning from responses provided to the user queries, their outcomes, past tickets, frequently asked questions by users, and the like. The virtual agent may be configured to leverage such machine learning (ML) learning capabilities and use natural language processing (NLP) to engage in interactions with the users. Furthermore, the virtual agent may also be caused to leverage unstructured or ‘private’ data—from external knowledge databases (such as Wikipedia for instance), online question-answer forums, run books and past chat transcripts to match problems that users are facing, expressed via natural language, to potential solutions in the unstructured corpora. Since there may be multiple possible underlying root-causes (and hence corresponding solutions) to the problem a user is facing, the system 200 may be caused to organize the information as a ‘knowledge graph’ and via natural language ‘question and answer’ (Q&A) based interaction, guide the user along a path in the knowledge graph until an explicit solution is reached. If no solution is discoverable with high confidence, the system 200 may be caused to forward the query to a resolver queue, effectively accelerating the time-to-resolution by creating a complete and accurate ticket.

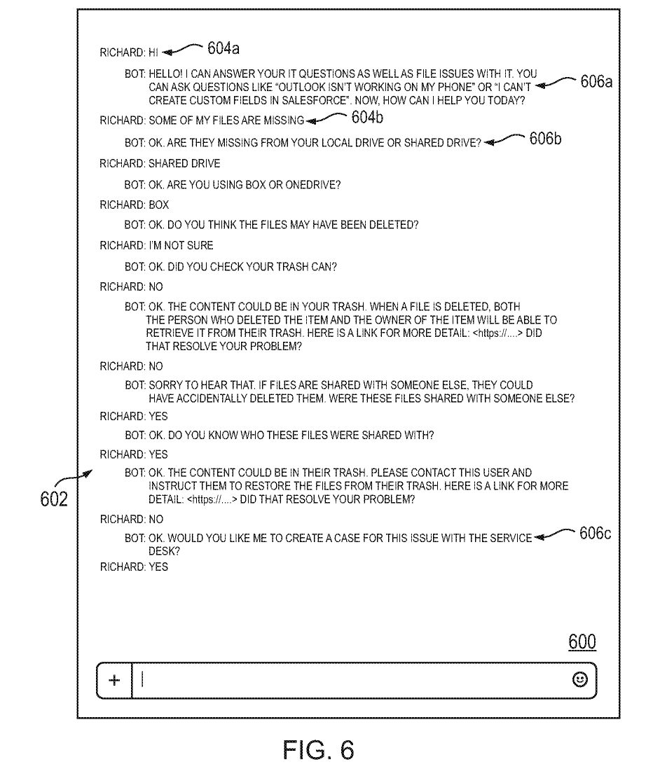

An example natural language based interaction between the user and the agent to facilitate determination of whether the query is a service request or an incident is depicted in FIG. 6.

Referring now to FIG. 6, a UI 600 displaying a natural language interaction 602 between a user and a virtual agent is shown, in accordance with an example embodiment. The UI 600 is similar to the UI 300 and is not explained again herein. The natural language interaction 602 is hereinafter referred to as interaction 602. The interaction entries provided by the user during the interaction 602 are exemplarily depicted to be tagged with label ‘RICHARD’, whereas the interaction entries provided by the virtual agent are exemplarily tagged with label ‘BOT’.

The user ‘RICHARD’ is depicted to have provided an input message 604a “Hi”, which may invoke a response 606a from the virtual agent. The response 606a is depicted to include a greeting message (for example, ‘Hello’) and suggestions of types of queries that the user may provide to the virtual agent. The user ‘RICHARD’ may ask a query 604b “Some of my files are missing”. In an embodiment, such a query may have been stored in the knowledge base 210 as an incident. As explained with reference to FIG. 2, the system 200, subsequent to determining the query to be an incident, may identify a reply to be provided to the user from the knowledge base 210 and provision the reply to the user. Instead of displaying a set of system queries, the system 200 may cause the virtual agent to respond with a natural language response 606b “Ok. Are they missing from your local drive or share drive?” Thereafter, the virtual agent may offer several suggestions to the user to trace the missing files as depicted in the interaction 602. In at least one example embodiment, the prompts for added information as well as the Yes/No checks guide the virtual agent for further diagnosis. As explained above, the virtual agent may leverage NLP and ML capabilities to engage in natural language interactions with users. As the replies provided by the virtual agent were deemed to be unsatisfactory for the user, the virtual agent may be configured to create a ticket (i.e. register a case) as depicted by a statement 606c from the virtual agent: “Ok. Would you like me to create a case for this issue with the service desk?”.

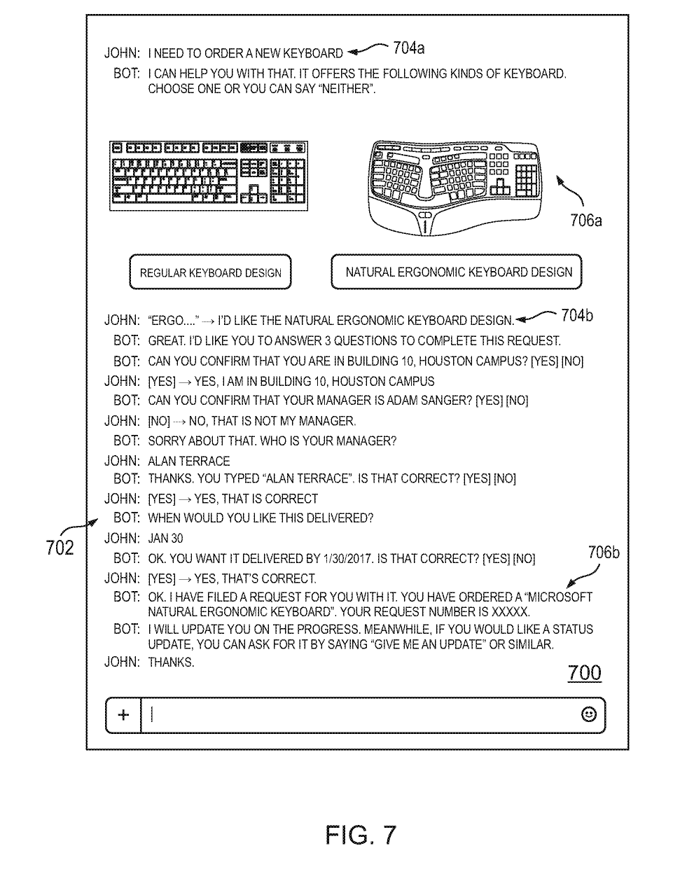

Another example natural language based interaction between the user and the agent to facilitate determination of whether the query is a service request or an incident is depicted in FIG. 7.

FIG. 7 shows a UI 700 displaying a natural language interaction 702 between a user and a virtual agent, in accordance with another example embodiment. The natural language interaction 702 is hereinafter referred to as interaction 702. The interaction entries provided by the user during the interaction 702 are exemplarily depicted to be tagged with label ‘JOHN’, whereas the interaction entries provided by the virtual agent are exemplarily tagged with label ‘BOT’.

The user ‘JOHN’ is depicted to have provided a query 704a “I need to order a new keyboard”, which may invoke a response 706a from the virtual agent. The response 706a is depicted to display two designs of keyboards to pick from, to the user. The user ‘JOHN’ may choose a keyboard design from among the displayed designs. In at least one example embodiment, the auto-complete feature may be configured to complete the user input and most importantly, format in the user response in a desired format as shown in the response 704b.

In an embodiment, such a query may have been stored in the knowledge base 210 as a service request. As explained with reference to FIG. 2, the system 200, subsequent to determining the query to be a service request, may select an appropriate service request form and update the service request form. Accordingly, the virtual agent may be caused to update a service request form as depicted by the response 706b.

It is noted that facilitating such natural language form of interactions between users and agent provides several advantages. For example, such interactions enable: (1) auto-resolution/deflection of service requests; (2) creation of complete and accurate tickets via natural language Q&A with users; (3) creation and maintenance of Enterprise knowledge graph; and (4) improve employee productivity and enabling IT teams to scale.

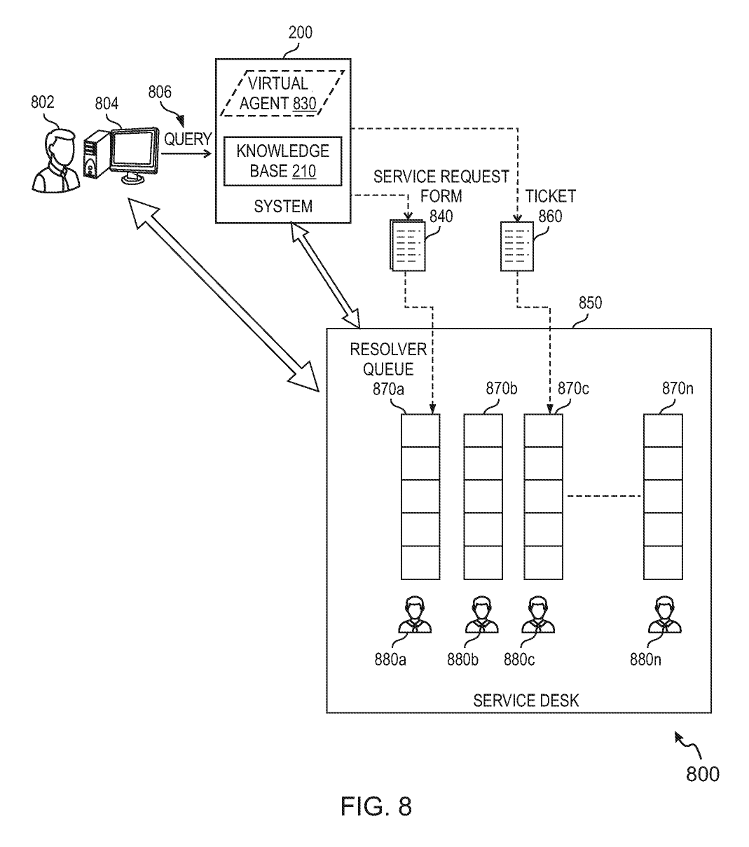

A process flow for facilitating resolution of user queries is explained next with reference to FIG. 8.

FIG. 8 shows an example representation of a process flow 800 for facilitating resolution of user queries, in accordance with an example embodiment. The process flow 800 depicts a user 802 associated with a workstation terminal 804. In an example scenario, the user 802 may seek assistance for a query from a service desk. For example, the user may contact a help section associated with a service desk, such as the service desk 850. The system 200 on account of being communicably associated with the service desk 850 may receive the input corresponding to the desired assistance and provision a UI, such as the UI 300 explained with reference to FIG. 3, to the user 802. The user 802 may provide a query 806 using the UI displayed on the workstation terminal 804. The system 200 may cause a virtual agent 830 to engage in an interaction (for example, a natural language interaction such as interactions 602 or 702, or a chat interaction such as the chat interactions, 302, 402 or 502) with the user to determine whether the query 806 is a service request or an incident. In case the query 806 is determined to be a service request, the system 200 may be caused to identify an appropriate service request form, such as the service request form 840, and update the service request form 840. The system 200 may further be caused to route the updated service request form 840 to a resolver queue 870a from among a plurality of resolver queues, such as resolver queues 870a, 870b, 870c to 870n, associated with the service desk 850. In case the query 806 is determined to be an incident, then the system 200 may be caused to identify a suitable reply from the knowledge base 210 and provide the reply to the user 802. If the reply is deemed to be unsatisfactory by the user 802, the system 200 may be caused to generate a ticket, such as the ticket 860 and route the ticket 860 to an appropriate resolver queue, such as the resolver queue 870c from among the plurality of resolver queues 870a-870n. As explained above, each resolver queue is associated with a resolver, i.e. a human agent. Accordingly, the resolver queues 870a, 870b, 870c and 870n are depicted to be associated with human agents 880a, 880b, 880c and 880n, respectively. The human agent may be specialized in handling queries related to a query domain assigned to respective resolver queue. The human agent may receive the service request form or the ticket, which are configured to be complete and accurate on account of being generated based on the interaction of the user 802 with the virtual agent 830, and assist the user 802 in resolving the query 806.

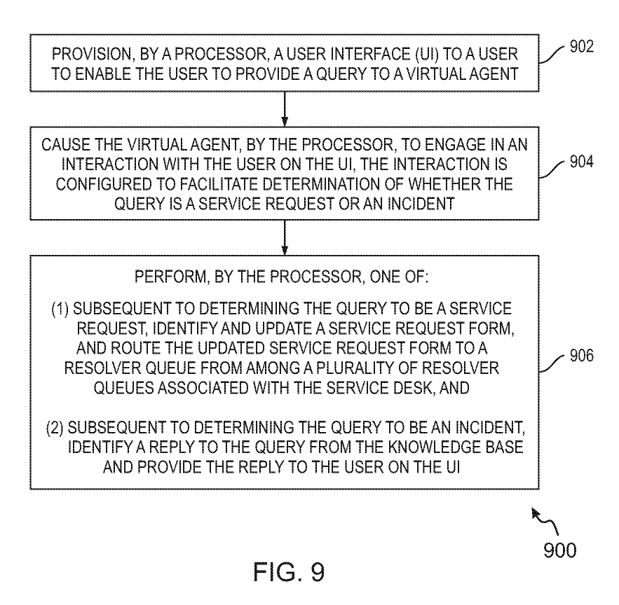

FIG. 9 is a flow diagram of a method 900 for facilitating query resolution at a service desk associated with an enterprise, in accordance with an example embodiment. The method 900, depicted in the flow diagram may be executed by, for example, the system 200 explained with reference to FIGS. 2-8. Operations of the flowchart, and combinations of operation in the flowchart, may be implemented by, for example, hardware, firmware, a processor, circuitry, and/or a different device associated with the execution of software that includes one or more computer program instructions for resolution of queries submitted by one or more users. The operations of the method 900 are described herein with help of the system 200. For example, one or more operations corresponding to the method 900 may be executed by a processor, such as the processor 202 of the system 200. It is noted that although the one or more operations are explained herein to be executed by the processor alone, it is understood that the processor is associated with a memory, such as the memory 204 of the system 200, which is configured to store machine executable instructions for facilitating the execution of the one or more operations. It is also noted that, the operations of the method 900 can be described and/or practiced by using a system other than the system 200. The method 900 starts at operation 902.

At operation 902 of the method 900, a user interface (UI) is provisioned to a user to enable the user to provide a query to a virtual agent. As explained with reference to FIG. 2, a user may seek assistance from a service desk associated with an enterprise. In response, a UI such as the UI 300 or the UI 400 explained with reference to FIGS. 3 and 4, respectively, may be provided to the user to enable the user to provide a query.

At operation 904 of the method 900, the virtual agent is caused to engage in an interaction with the user. The interaction is configured to facilitate determination of whether the query is a service request or an incident. The interaction between the virtual agent and the user can be executed as exemplarily explained with reference to FIGS. 3, 4 and 5A-5B. More specifically, the user may be displayed one or more system queries and the user may be asked to identify a system query matching the user query. Such a step may be repeated a predefined number of times, for example two or three times, to facilitate determination of whether the query is a service request or an incident. If the identified matching system query is classified in a knowledge base as a service request, then the user query may be determined to be a service request. Alternatively, if the identified matching system query is classified in the knowledge base as an incident, then the user query may be determined to be an incident. In some embodiments, the virtual agent may be caused to preclude display of matching system queries and instead communicate in natural language form with the user to facilitate determination of whether the query is a service request or an incident, as explained with reference to FIGS. 6 and 7.

At operation 906 of the method 900, one of (1) subsequent to determining the query to be a service request, a service request form is identified, updated and routed to a resolver queue from among a plurality of resolver queues associated with the service desk, and (2) subsequent to determining the query to be an incident, identify a reply to the query from the knowledge base and provide the reply to the user on the UI, is performed. The handling of the query subsequent to determining the query to be a service request or an incident may be performed as explained with reference to FIGS. 2 and 6 and is not explained herein. In at least one example embodiment, a human agent associated with the resolver queue may resolve the query provided by the user, thereby assisting the user. The method 900 stops at operation 906.

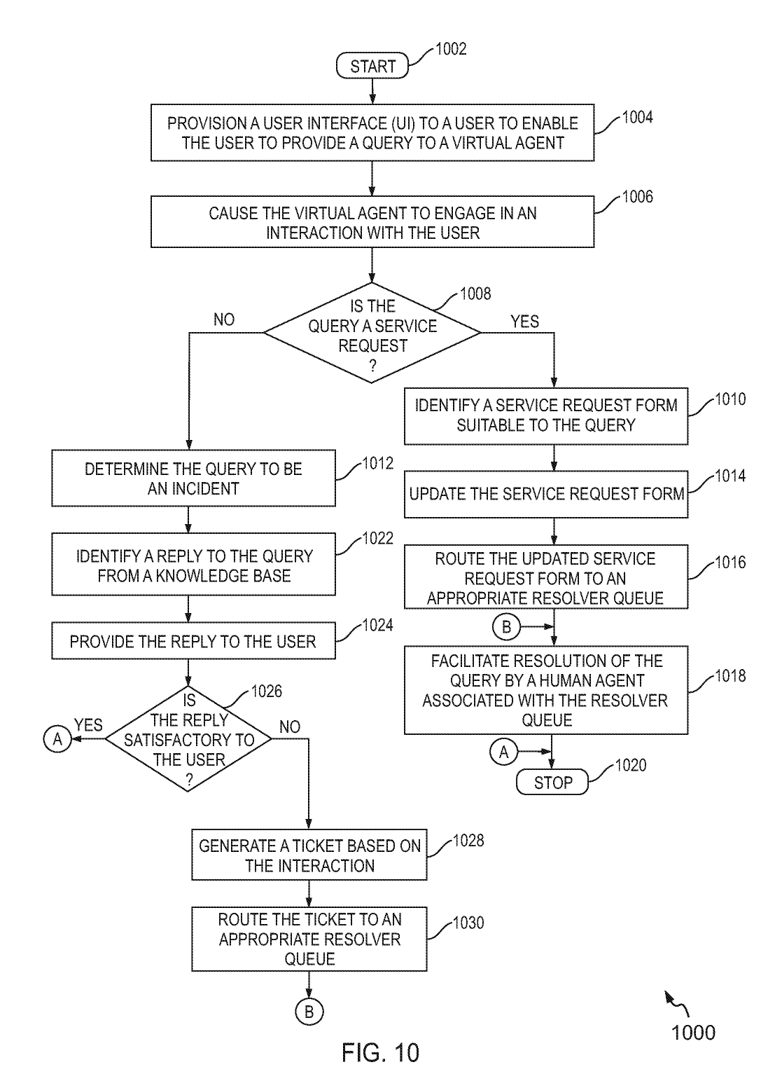

Another method for query resolution at a service desk associated with an enterprise is explained with reference to FIG. 10.

FIG. 10 is a flow diagram of a method 800 for facilitating query resolutions at a service desk associated with an enterprise, in accordance with another example embodiment. The method 1000 may be performed by the system 200 explained with reference to FIGS. 2 to 8. The method 1000 starts at operation 1002. At operation 1002, a user may seek assistance from a service desk for resolution of a query.

At operation 1004 of the method 1000, a user interface (UI) is provisioned to a user to enable the user to provide a query to a virtual agent. At operation 1006, the virtual agent is caused to engage in an interaction with the user. At operation 1008, it is determined whether the query is a service request. If the query is determined to be a service request, then operation 1010 is performed. If the query is determined to not be a service request, then the query is determined to be an incident at operation 1012.

At operation 1010, a service request form suitable to the query is identified. At operation 1014, the identified service request form is updated. At operation 1016, the updated service request form is routed to an appropriate resolver queue. At operation 1018, a resolution to the query is facilitated by a human agent associated with the resolver queue. The method 1000 stops at operation 1020.

Upon determining the query to be an incident at operation 1012, operation 1022 is performed. At operation 1022, a reply to the query is identified from a knowledge base. At operation 1024, the reply is provisioned to the user. At operation 1026 it is determined, whether the reply is deemed to be satisfactory by the user. If the reply is deemed to be satisfactory, then the method 1000 ends at operation 1020. If the reply is deemed to be unsatisfactory, then at operation 1028, a ticket is generated based on the interaction. At operation 1030, the ticket is routed to an appropriate resolver queue. Thereafter, operation 1018 is performed. At operation 1018, a resolution to the query is facilitated by a human agent associated with the resolver queue. The method 1000 stops at operation 1020.

Various embodiments of the present technology provide a method, apparatus and computer program product that are capable of overcoming drawbacks of conventional query resolution mechanisms and providing additional benefits. More specifically, various embodiments of the present technology facilitate an operator less service desk that uses virtual agents to determine whether a user query is a service request or an incident. If the query is a service request, an appropriate service request form is identified based on the interaction between the user and the virtual agent, and routed to a relevant resolver queue. If the query is an incident, then a response to the query is identified from the knowledge base and provided to the user. If the user is not satisfied by the response, then a complete and accurately filled ticket is generated based on the interaction and routed to an appropriate resolver queue of the service desk for resolution. Such resolution of queries precludes the need for the user to determine whether a query is a service request or an incident and then identify an appropriate form. As such, errors in incorrect determination of the type of query or the improper selection of service request forms are avoided by using the proposed solution. Moreover, the techniques suggested herein preclude manual filling up of information by triaging agents to generate complete and accurate tickets. As such, errors in manual generation of tickets and routing of tickets to the correct resolver queues are avoided, thereby facilitating an efficient mechanism of query resolution for the users of the enterprise.

The disclosed methods 900 and 1000 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer embedded in a device, such as a laptop computer, net book, web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The embodiments illustrated and described herein as well as embodiments not specifically described herein but within the scope of aspects of the invention constitute exemplary system means for facilitating resolution of user queries at a service desk. For example, the elements illustrated and described with reference to FIGS. 2 to 8, when configured, under control of the processor 202 and computer program code in the memory 204 to perform the operations illustrated and described with reference to FIGS. 2 to 8, constitute means for provisioning a user interface (UI) to a user to enable the user to provide a query to a virtual agent; means for causing the virtual agent to engage in an interaction with the user, the interaction configured to facilitate determination of whether the query is a service request or an incident, the interaction between the virtual agent and the user facilitated using the UI; and means for performing one of: (1) subsequent to determining the query to be the service request: updating a service request form, wherein the service request form is identified from among a plurality of service request forms based on the interaction, identifying a resolver queue relevant to the service request, the resolver queue identified from among a plurality of resolver queues associated with the service desk, and routing the updated service request form to the resolver queue identified to be relevant to the service request; and (2) subsequent to determining the query to be the incident: identifying a reply to the query from a knowledge base, and provisioning the reply to the user using the UI.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the system 200, the processor 202, the memory 204, the I/O module 206 and the communication interface 208 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIGS. 9 and 10). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A system for facilitating query resolution at a service desk associated with an enterprise, the system comprising:
at least one processor; and
a memory having stored therein machine executable instructions, that when executed by the at least one processor, cause the system to:
provision a user interface (UI) to a user to enable the user to provide a query to a virtual agent;
cause the virtual agent to engage in an interaction with the user, the interaction configured to facilitate determination of whether the query is a service request or an incident, the interaction between the virtual agent and the user facilitated using the UI; and
perform one of:
subsequent to determining the query to be the service request:
update a service request form, wherein the service request form is identified from among a plurality of service request forms based on the interaction,
identify a resolver queue relevant to the service request, the resolver queue identified from among a plurality of resolver queues associated with the service desk, and
route the updated service request form to the resolver queue identified to be relevant to the service request; and
subsequent to determining the query to be the incident:
identify a reply to the query from a knowledge base, and
provision the reply to the user using the UI.

2. The system as claimed in claim 1, wherein the interaction between the virtual agent and the user comprises:
displaying one or more system queries stored in the knowledge base to the user on the UI; and
causing the virtual agent to request the user to identify a system query substantially matching the query provided by the user from among the one or more system queries, wherein the query is determined to be the service request or the incident based on the identification of a matching system query by the user.

3. The system as claimed in claim 2, wherein the system is further caused to:
repeat, a predefined number of times, steps of displaying system queries and causing identification of a matching system query from among a different set of system queries from the knowledge base if an user input in response to the displaying the one or more system queries is indicative of no match between the one or more system queries and the query provided by the user.

4. The system as claimed in claim 1, wherein the virtual agent is configured to engage in a natural language based interaction with the user to facilitate determination of whether the query is the service request or the incident.

5. The system as claimed in claim 1, wherein the system is further caused to:
generate a ticket corresponding to the query if the reply provided to the user is deemed to be unsatisfactory by the user, the ticket generated based on the query and the interaction between the user and the virtual agent; and
route the ticket to a resolver queue from among the plurality of resolver queues, the resolver queue identified to be relevant to the query.

6. The system as claimed in claim 5, wherein each resolver queue from among the plurality of resolver queues is associated with at least one human agent capable of assisting users with respective queries related to a query domain associated with the each resolver queue.

7. The system as claimed in claim 6, wherein the system is further caused to:
facilitate resolution of the query by the at least one human agent associated with the resolver queue identified to be relevant to the query.

8. The system as claimed in claim 7, wherein the system is further caused to:
identify an information gap in the knowledge base subsequent to the provisioned reply being deemed unsatisfactory by the user; and
update the knowledge base with the resolution to the query provided by the human agent in response to the identification of the knowledge gap, the updating of the knowledge base configured to address the identified information gap in the knowledge base.

9. The system as claimed in claim 1, wherein the virtual agent is capable of conducting the interaction in form of a voice conversation or a chat conversation with the user using the UI.

10. The system as claimed in claim 1, wherein the system is further caused to:
provide notifications to one or more other users anticipated to have queries similar to the query provided by the user; and
facilitate resolution to the similar queries based on the interaction between the virtual agent and the user.

11. The system as claimed in claim 1, wherein the system is further caused to:
retrieve data from one or more public data sources and private data sources, wherein the data corresponds to user queries anticipated at the service desk of the enterprise; and
augment information stored in the knowledge base with the retrieved data.

12. A computer-implemented method for facilitating query resolution at a service desk associated with an enterprise, the method comprising:
provisioning a user interface (UI) to a user, by a processor, to enable the user to provide a query to a virtual agent;
causing the virtual agent to engage in an interaction with the user by the processor, the interaction configured to facilitate determination of whether the query is a service request or an incident, the interaction between the virtual agent and the user facilitated using the UI; and
performing, by the processor, one of:
subsequent to determining the query to be the service request:
updating a service request form, wherein the service request form is identified from among a plurality of service request forms based on the interaction,
identifying a resolver queue relevant to the service request, the resolver queue identified from among a plurality of resolver queues associated with the service desk, and
routing the updated service request form to the resolver queue identified to be relevant to the service request; and
subsequent to determining the query to be the incident:
identifying a reply to the query from a knowledge base, and
provisioning the reply to the user using the UI.

13. The method as claimed in claim 12, wherein causing the interaction between the virtual agent and the user comprises:
displaying one or more system queries stored in the knowledge base to the user on the UI; and
causing the virtual agent to request the user to identify a system query substantially matching the query provided by the user from among the one or more system queries, wherein the query is determined to be the service request or the incident based on the identification of a matching system query by the user.

14. The method as claimed in claim 13, further comprising:
repeating a predefined number of times, by the processor, steps of displaying system queries and causing identification of a matching system query from among a different set of system queries from the knowledge base if an user input in response to the displaying the one or more system queries is indicative of no match between the one or more system queries and the query provided by the user.

15. The method as claimed in claim 12, wherein the virtual agent is configured to engage in a natural language based interaction with the user to facilitate determination of whether the query is the service request or the incident.

16. The method as claimed in claim 12, further comprising:
generating, by the processor, a ticket corresponding to the query if the reply provided to the user is deemed to be unsatisfactory by the user, the ticket generated based on the query and the interaction between the user and the virtual agent; and
routing, by the processor, the ticket to a resolver queue from among the plurality of resolver queues, the resolver queue identified to be relevant to the query, wherein each resolver queue from among the plurality of resolver queues is associated with at least one human agent capable of assisting users with respective queries related to a query domain associated with the each resolver queue.

17. The method as claimed in claim 16, further comprising:
identifying, by the processor, an information gap in the knowledge base subsequent to the provisioned reply being deemed unsatisfactory by the user; and
updating, by the processor, the knowledge base with resolution to the query provided by a human agent in response to the identification of the knowledge gap, the updating of the knowledge base configured to address the identified information gap in the knowledge base.

18. The method as claimed in claim 12, further comprising:
providing, by the processor, notifications to one or more other users anticipated to have queries similar to the query provided by the user; and
facilitating, by the processor, resolution to the similar queries based on the interaction between the virtual agent and the user.

19. The method as claimed in claim 12, further comprising:
retrieving, by the processor, data from one or more public data sources and private data sources, wherein the data corresponds to user queries anticipated at the service desk of the enterprise; and
augmenting, by the processor, information stored in the knowledge base with the retrieved data.

20. A computer program product comprising at least one computer-readable storage medium, the computer-readable storage medium comprising a set of instructions which, when executed by one or more processors, cause an electronic device to:
provision a user interface (UI) to a user to enable the user to provide a query to a virtual agent;
cause the virtual agent to engage in an interaction with the user, the interaction configured to facilitate determination of whether the query is a service request or an incident, the interaction between the virtual agent and the user facilitated using the UI; and
perform one of:
subsequent to determining the query to be the service request:
update a service request form, wherein the service request form is identified from among a plurality of service request forms based on the interaction,
identify a resolver queue relevant to the service request, the resolver queue identified from among a plurality of resolver queues associated with the service desk, and
route the updated service request form to the resolver queue identified to be relevant to the service request; and
subsequent to determining the query to be the incident:
identify a reply to the query from a knowledge base, and
provision the reply to the user using the UI.

21. The computer program product as claimed in claim 20, wherein the interaction between the virtual agent and the user comprises:
displaying one or more system queries stored in the knowledge base to the user on the UI; and
causing the virtual agent to request the user to identify a system query substantially matching the query provided by the user from among the one or more system queries, wherein the query is determined to be the service request or the incident based on the identification of a matching system query by the user, and wherein the electronic device is caused to repeat, a predefined number of times, steps of displaying system queries and causing identification of a matching system query from among a different set of system queries from the knowledge base if an user input in response to the displaying the one or more system queries is indicative of no match between the one or more system queries and the query provided by the user.

22. The computer program product as claimed in claim 20, wherein the virtual agent is configured to engage in a natural language based interaction with the user to facilitate determination of whether the query is the service request or the incident.

23. The computer program product as claimed in claim 20, wherein the electronic device is further caused at least in part to:
generate a ticket corresponding to the query if the reply provided to the user is deemed to be unsatisfactory by the user, the ticket generated based on the query and the interaction between the user and the virtual agent; and
route the ticket to a resolver queue from among the plurality of resolver queues, the resolver queue identified to be relevant to the ticket, wherein each resolver queue from among the plurality of resolver queues is associated with at least one human agent capable of assisting users with respective queries related to a query domain associated with the each resolver queue.
